(19) United States
(12) Patent Application Publication
(10) Pub. No.: US 2002/0165320 A1
(43) Pub. Date: Nov. 7, 2002

(54) Dielectronic composition for manufacturing insulating structures

(76) Inventors: Gerardo Pagaza Melero, Cuajimalpa (MX); Saturnino Enrique Martinez Herrera, Naucalpan (MX); Victor Pagaza Melero, Mexico, D.F. (MX)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/114,361

(22) Filed: Apr. 2, 2002

Related U.S. Application Data
(63) Continuation of application No. PCT/MX01/00056, filed on Aug. 2, 2001.

(30) Foreign Application Priority Data
Aug. 2, 2000 (MX) 007626

(51) Int. Cl. C08F 8/00; C08L 63/00

(52) U.S. Cl. 525/107; 525/127; 525/165

(57) ABSTRACT

The present invention is related with a dielectric composition for the manufacture of an insulating structure of the type that comprises at least a dielectric resin. The composition comprises granules of a thermoset polymer and a dielectric resin in a ratio thermoset polymer/dielectric resin in the scale of 2:1 to 20:1, which allows it to support voltages of at least 45 kV and to have resistances of at least 25 MΩ. The invention further comprises dielectric structures obtained from the composition, which can be increased in their dielectric strength by means of a layer of dielectric resin.

### FIELD OF THE INVENTION

The present invention is related to the manufacturing techniques of dielectric materials, and more particularly it is related to a dielectric composition for manufacturing insulating structures.

### BACKGROUND OF THE INVENTION

As it is known, there exist a great variety of dielectric compositions manufactured from diverse resins for their application in the electrical industry, for example in the manufacture of insulating coatings for high-tension conductors.

On the other hand, repair and maintenance of high-tension equipment, such as electric sub-stations, demands the necessity of having an insulating material so that the personnel in charge of manipulating high-tension equipment can work without the risk of an electric shock due to ground contact. For the sake of the present invention, it is understood as insulating structures those coatings, products and/or materials allowing electrical insulation of a person located near a high-voltage source, or those that allow to electrically insulate diverse objects, apparatus, machines, tools, devices and/or equipment from a high-voltage source.

For example, there exist nowadays some insulating structures having a mat or platform shape, which insulate users that manipulate high-tension equipment, the majority of which are manufactured of glass fiber.

Certainly) glass fiber has great insulating capacity. However, the platforms made of this material have the inconvenience of being slippery, thus putting the user of the same in risk. Additionally the manufacture of such platforms has an elevated cost, since in order to avoid holes in the glass fibber wherein air could infiltrate, glass fibber must be subjected to very high pressure, which complicates its processing.

There exist other materials which dielectric capacity is known, as those used for coating cooper cables or other electricity conducting metals. However, the majority of them are not used in high-tension applications due to the high cost or to the difficulty for applying the materials onto the surfaces to be insulated.

Additionally, the use of recycled materials has been dismissed due to their lack of homogeneity in as much as it is impossible to know exactly the composition of the used materials, in addition to the possibility of forming holes that could reduce the dielectric capacity of the material and of the insulating structures manufactured with the same.

Other material that could be used in the manufacture of insulating mats or platforms is wood. However, said material presents the inconvenient of suffering wearing in very short time due to handling and moisture among other factors. Therefore, this material does not guarantee a reliable insulation after a very short lifetime, thus putting in risk the user as the material is prone to absorb moisture.

Consequently, for long it has been sought to overcome the inconveniences of the currently used insulating structures by developing an insulating structure that, as it shows a great insulating capacity, has lower cost by the use of recycled materials, further having non-slippery properties suitable for manufacturing platforms or mats among other insulating structures.

### OBJECTIVES OF THE INVENTION

Having in mind the defects of the prior art, it is an object of the present invention to provide a dielectric composition for manufacturing dielectric structures from recycled material.

Another object of the present invention is to provide an insulating structure with large dielectric capacity being capable of electrically shielding with safety a user working with high-tension equipment.

An additional object of the present invention is to provide an insulating structure having a large dielectric capacity and being capable of electrically shielding diverse objects, apparatus, machines, tools, devices and/or equipment that is near to a high-tension source.

A further object of the present invention is to provide an insulating structure that is non-slippery and does not slide with respect to the floor or to a user.

Another further object of the present invention is to provide an insulating structure that does not keep moisture.

### BRIEF DESCRIPTION OF THE DRAWINGS

The novel features that are considered characteristic of the present invention are set forth with particularity in the appended claims. The operation together with other objects and advantages thereof, will be best understood in the following detailed description of certain embodiments, when read in connection with the accompanying drawings, in which:

FIG. 1 is a cross section view of an insulating structure built in accordance with the principles of the present invention.

FIG. 2 is a cross section view of a second embodiment of an insulating structure built in accordance with the principles of the present invention.

FIG. 3 is a cross section view of a third embodiment of an insulating structure built in accordance with the principles of the present invention.

FIG. 4 is a cross section view of a fourth embodiment of an insulating structure built in accordance with the principles of the present invention.

FIG. 5 is a bottom view of a fifth embodiment of an insulating structure built in accordance with the principles of the present invention.

FIG. 6 is a cross section view of a sixth embodiment of an insulating structure built in accordance with the principles of the present invention.

FIGS. 7A, 7B and 7C are electric diagrams of mountings for a dielectric strength test using high tension of direct current.

FIGS. 8A and 8B are electric diagrams of mountings for a dielectric strength test using high tension of alternate current.

FIG. 9 is an electric diagram of the mounting used for a dielectric strength test using high tension from an impulse generator.

FIG. 10 is an electric diagram of the mounting used in an insulating resistance test.

### DETAILED DESCRIPTION

It has been surprisingly found by means of laboratory tests, that a mixture of granules of a thermoset polymer, preferably vulcanized rubber; and, a s dielectric resin, preferably selected between polyurethane, epoxy resins, polyester resins, and/or combinations thereof; although they are materials with different phase and prone to form empty spaces between them while mixing, is capable of resisting a voltage of at least 45000 volts, which is suitable for protecting a user of high-tension equipment, which generally operates at 23000 volts. Moreover, surprisingly has it been found that the mixture of thermoset polymer with polymers that release gases during polymerisation does not diminishes sensibly the dielectric capacity of the material.

The composition of thermoset polymer with a dielectric resin comprises preferably granules of the thermoset polymer with a size in the scale of 0.17 mm (80 mesh) to 11.2 mm (7/16 mesh), and a dielectric resin in a thermoset polymer/dielectric resin proportion within the scale of 2:1 to 20:1, preferably 5:1.

In a preferred embodiment, the thermoset polymer is a vulcanised rubber preferably selected among EPDM, styrene-butadiene rubber (SBR); natural synthetic rubbers, and/or combinations thereof, preferably obtained from waste recycling.

On the other hand, the dielectric resin is selected between polyurethane, epoxy resins, polyester resins and/or combinations thereof. More preferably, there are used polyurethanes obtained from toluene diisocyanate and a polyol having a molecular weight of approximately 3300. In a preferred embodiment, 5 to 40 parts of toluene-diisocyanate isomers per 100 parts of polyol are used approximately; preferably 8 to 33 parts of toluene-diisocyanate per hundred parts of polyol are used.

The process for manufacturing the composition comprises a mixing stage wherein the thermoset polymer is mixed with the dielectric resin in the preferred proportions; and, a stage of applying and curing of the mixture thermoset polymer/dielectric resin, preferably selected among cast, spray, injection, calendering, surface dispersion, dipping and extrusion molding, among others.

In a preferred embodiment the stage of applying and curing is performed by means of cast molding by depositing the mixture into a mold with a design suitable for the final product, which can be performed with the application of heat or without it, allowing the resin to cure by polymerization. Preferably heat and pressure is applied so as to cure more rapidly and to achieve the compaction of the material. In a preferred embodiment, there are used temperatures within the scale of 50 to 150° C., approximately, and pressures within a scale of 0 to 400 lb/in² approximately, although such conditions are not necessary for obtaining the properties of electric insulation desired in the composition, unlike other known compositions.

In another embodiment, the stage of application and curing is carried out by dipping a product to be electrically insulated into the granulated vulcanized rubber/resin mixture.

Once the mixture is cured, an insulating structure is formed which is capable of resisting a voltage of at least of 45000 volts. It is worth to emphasize that the maximum voltage usually found in high-voltage areas where persons or equipment could be found is of 23000 volts.

In an additional embodiment, the insulating structure is complemented with a second layer of dielectric resin in at least one of the surfaces of the insulating structure as a sealing means, selected between polyurethane, epoxy resins, polyester resin, and/or combinations thereof, preferably polyurethane, for achieving in that way the total dielectric strength of the material. More preferably polyurethane obtained from toluene diisocyanate isomers and a polyol with a molecular weight of approximately 3300 is used. In a preferred embodiment, 5 to 40 parts of toluene diisocyanate isomer per 100 parts of polyol are used, approximately; preferably 8 to 33 of toluene diisocyanate isomer per 100 parts of polyol are used.

Once the second layer of dielectric resin is applied onto the insulating structure, the possibility of current pass through the insulating structure finally obtained is optimized, since it is prevented the passthrough of air between the empty spaces that could exist due to the chemical reaction itself, performed during the curing step, or to the lack of homogeneity in the mixture in the mixing stage, thus ensuring the total dielectric capacity of the material.

In this embodiment wherein a second layer of dielectric resin is applied, the application and curing stage can be divided in several stages, depending on the position in which the second resin layer is desired.

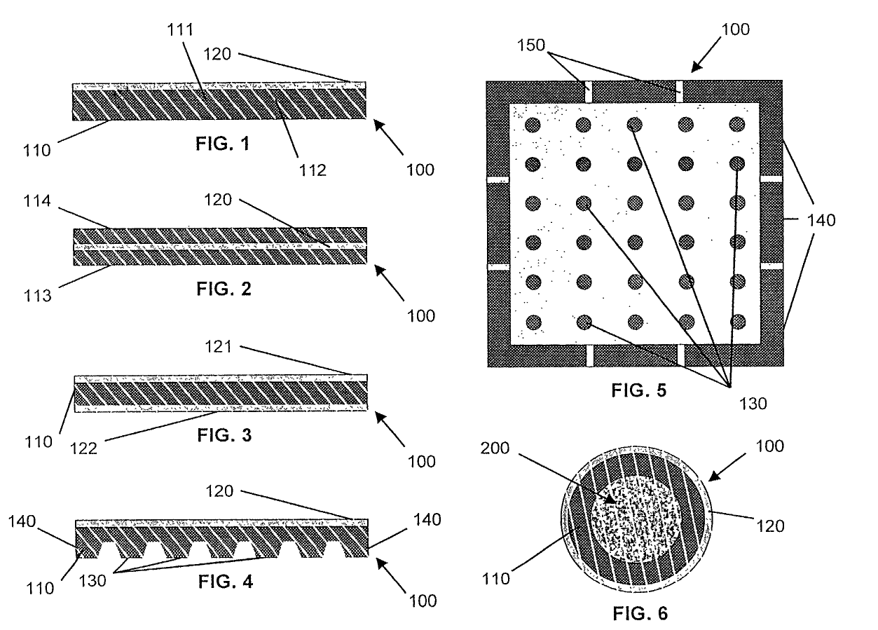

Having now more particular reference to the drawings, and more specifically to FIG. 1 thereof, this shows a preferred embodiment of an insulating structure 100 of the present invention, which comprises at least a dielectric substrate 110 formed from the composition of the present invention, which in turn comprises granules 111 of a thermoset polymer and dielectric resin 112. In the embodiment shown in the figure, the insulating structure further comprises a dielectric resin substrate joined to substrate 110.

In this case, the application and curing stage is carried out according to what was described herein above, applying a layer of dielectric resin onto at least one of the surfaces of the insulating structure once the curing of the mixture thermoset polymer/dielectric resin has been made.

Having now reference to FIG. 2, there is shown a second embodiment of insulating structure 100, wherein it is presented a dielectric resin substrate 120 located between a first substrate 113 and a second substrate 114 of thermoset polymer/dielectric resin mixture. In this embodiment the application and curing stage can be divided into two stages, a first stage of application and curing according to the above description in order to form first substrate 113; a stage of application of dielectric resin 120 onto at least one of the surfaces of the first substrate in order to end with a second stage of application and curing according to the prior description in order top form the second substrate 114 of thermoset polymer/dielectric resin mixture.

FIG. 3 shows a third embodiment of insulating structure 100, wherein it is presented a substrate of thermoset polymer/dielectric resin 100 located between first and second resin substrates 121 and 122. In the described embodiment, the application and curing stage can be divided again in three stages, one of application and curing according to the above description in order to form substrate 110, a first stage of dielectric resin 121 application onto at least one of the surfaces of the substrate 110, and a second application stage of dielectric resin onto the surface of the first substrate opposite to the dielectric resin 121 in order to form the second resin substrate 122.

Now then, FIG. 4 shows a fourth embodiment of insulating structure 100, having mat shape and wherein the substrate of thermoset polymer/dielectric resin mixture 110 presents a plurality of supports 130, which in addition to giving a dielectric structure, allow water flow and not-retention of the same when the structure is in use, thus making more efficient the performance and avoiding the material to be in excessive contact with water. In an additional embodiment, the dielectric structure comprises a support edge 140 along all the bottom periphery of insulating structure 100, which functions as reinforcement to the plurality of supports 130.

As it might be observed from FIG. 5, it shows a bottom plan view of the insulating structure 100 of FIG. 4. In an additional embodiment the edge of support 140 includes a plurality of channels 150 which allow water flow of said structure.

On the other hand, FIG. 6 shows a fifth embodiment of the insulating structure 100, where the first substrate of the thermoset polymer/dielectric resin mixture 110 is placed as coating on objects, apparatus, machines, tools, devices and/or equipment. In the embodiment shown in FIG. 6, a post 200 is coated by substrate of thermoset polymer/dielectric resin 110, which in turn, is coated by the substrate of dielectric resin 120. In this embodiment the thermoset polymer/dielectric resin mixture 110 is applied onto the surface of the post and is allowed to cure, so that afterwards the dielectric resin is applied onto the surface of substrate 110, thus forming 120.

The following examples are destined to illustrate the scope of the present invention in all aspects, which are presented with illustrative purposes but do not restrict it.

### EXAMPLES

The dielectric strength is defined as the maximum intensity of electric field that a dielectric material can support without breakage. In order to determine it, the following tests were carried out.

Test 1:

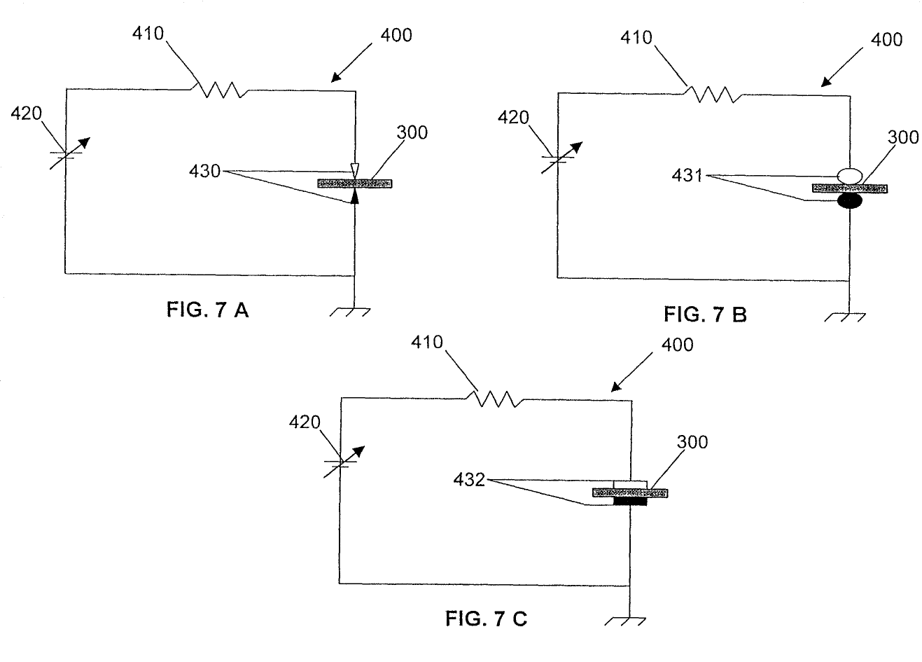

A sample of 1 mm of thickness of the insulating structure to be tested was subjected to steady tension of direct current in accordance with circuit 400 shown in FIGS. 7A, 7B and 7C. By means of said circuit, tension was risen gradually by 3 kV each second until trying to reach the breakage voltage, using for this purpose a variable resistance 410 having values of 10 to 100 MΩ and a high-tension direct current source 420 from where voltages within 0 to 50 kV can be provided.

Test 2:

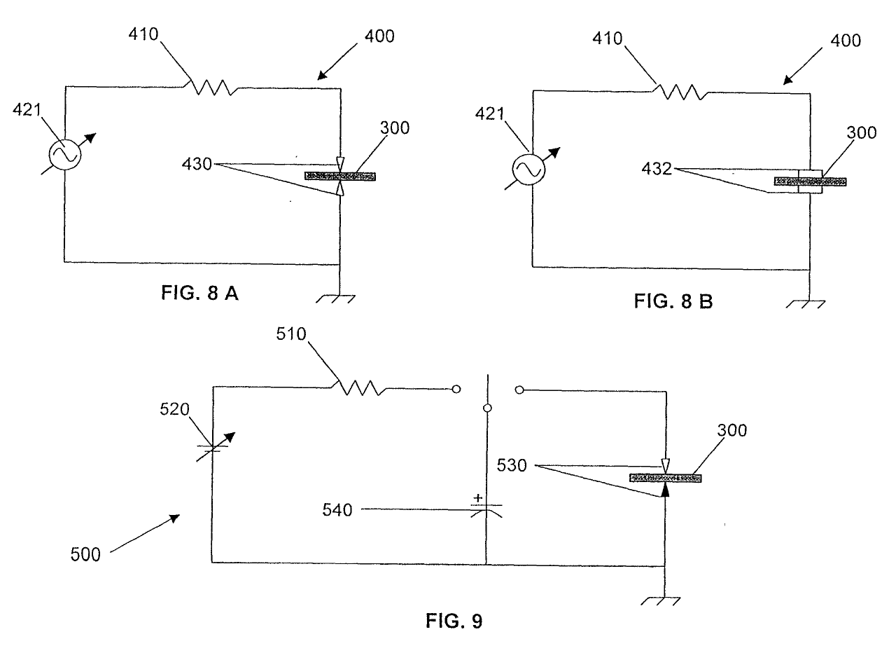

A sample of 1 mm of thickness of insulating structure 300 to be tested were subjected to steady tension of alternate current in accordance with circuit 400 shown in FIGS. 8A and 8B, wherein tension was risen gradually in 3 kV each second until trying to reach the breakage voltage, using for this purpose a variable resistance 410 having values from 10 to 100 Ω and a high tension alternating current source 420, from where voltages within 0 and 60 kV can be provided.

Test 3:

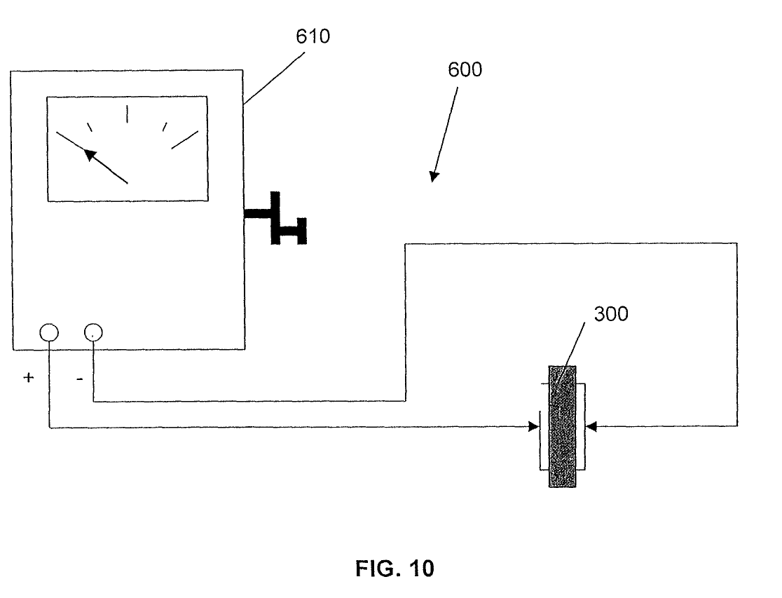

The insulating structure to be tested was subjected to different tensions by means of an impulse generator working in accordance with circuit 500 shown in FIG. 9, until reaching the breakage tension. Capacitor 540 was charged until reaching the desired tension by using the high voltage direct current source 520 and the variable resistance 510 with values from 10 to 100 MΩ. Once the desired tension was reached, the voltage from the capacitor was discharged on the sample of 1 mm of the tested structure 300. This test is known as impulse test for determining the breakage tension.

Test 4:

By means of a Yokogawa type megohmmeter 610 in accordance with circuit 600 shown in FIG. 10, it was tested the insulating resistance of a sample of 1 mm in thickness of the insulating structure 300 to be tested.

An insulating structure manufactured from the composition of the present invention was subjected to the four tests, as well as an insulating structure manufactured from pure vulcanized rubber. The insulating structure of the present invention contained vulcanized rubber granules with an approximated size of 1 mm obtained from tire recycling, mixed with polyurethane, keeping a proportion of granulated vulcanized rubber/polyurethane within the scale of 5:1.

As it refers to test 1, upon elevation of electric tension, surprisingly there was not found breakage in both materials, although tension was continued to elevate until reaching 45 kV, much higher than the 23 kV that it is supposed to support as a minimum. The same result was obtained when repeating this test with both structures by using electrodes with different shapes, namely: tip electrodes 430 (FIG. 7A), hemispherical electrodes 431 (FIG. 7B) and flat electrodes 432 (FIG. 7C). It is worth to emphasize that it results unexpected that the composition containing waste material supports the same voltage as the virgin vulcanized rubber, since at simple sight inspection, the composition of the present invention seems to be very poor in homogeneity and gives the impression that it would never support such a high voltage in a sample of 1 mm of thickness.

As for test 2, the result of test 1 was repeated, thus verifying that the composition does work for both direct and alternate current.

As for test 1, test 2 was repeated with both structures using electrodes having different shapes, namely: tip electrodes 430 (FIG. 8A), and flat electrodes 432 (FIG. 8B). In all events the same results were obtained.

Now then, test 3 allowed observing a breakage of the sample of 1 mm at tensions of the order of 45 kV for the composition of the present invention. However, a sample of 1 mm of the natural rubber structure subjected to the same test, observed breakage at tensions of the order of 50 kV. It is not less surprising, therefore, that a material obtained from waste materials allows obtaining a high dielectric capacity, of only 5 kV in difference with respect to the virgin material.

As it refers to test 4 of insulating, a decrease in the insulating resistance of up to 30-40 MΩ was observed in those zones wherein the mixture is not homogeneous, which however, is enough for bringing an adequate protection in this kind of materials, which has to be of 23 kV, requiring at least 20 MΩ. Likewise, in some zones of the structure made of the composition of the present invention, very high insulating resistances were reached (infinite indication).

As it can be observed from the above examples, the insulating structure of the present invention, built from recycled materials presents insulating properties very similar to those of the pure vulcanized rubber. Therefore it can be easily used for electrically shielding a user of high tension equipment, since generally such equipment works at voltages of the order of 23 kV, which is easily over-passed with no difficulty by the 45 kV that the insulating structure of the present invention can support at least.

In accordance with the above description, it can be observed that the dielectric composition as well as the insulating structure obtained therefrom have been ideated for electrically insulating a user, and it shall be evident for those skilled in the art that the embodiments of the composition and insulating structure described herein above and illustrated in the accompanying drawings, are only illustrative but do not limit the present invention, since numerous changes can be made in its details without falling apart of the scope of the invention, such as diverse methods for curing the composition, diverse coated materials or insulating structures obtained with diverse shapes.

Although certain specific embodiments of the present invention have been illustrated and described above, it is to be emphasized that many modifications thereof are possible, such as the use of diverse waste materials or virgin materials granulated with the purpose of being used in the composition of the present invention. The present invention, therefore, is not to be restricted except insofar as necessitated by the prior art and by the spirit of the appended claims.

1. A dielectric composition for the manufacture of an insulating structure of the type that comprises at least a dielectric resin, characterized by comprising granules of a thermoset polymer and a dielectric resin in a ratio of thermoset polymer/dielectric resin in the scale of 2:1 to 20:1, which allows it to support voltages of at least 45 kV and to have resistances of at least 25 MΩ.

2. A dielectric composition for the manufacture of an insulating structure, according to claim 1, further characterized in that the ratio thermoset polymer/dielectric resin is 5:1.

3. A dielectric composition for the manufacture of an insulating structure, according to claim 1, further characterized in that the thermoset polymer is vulcanized rubber.

4. A dielectric composition for the manufacture of an insulating structure, according to claim 2, further characterized in that the rubber is selected among EPDM, SBR, natural rubbers, synthetic rubbers and/or combinations thereof.

5. A dielectric composition for the manufacture of an insulating structure, according to claim 2, further characterized in that the rubber is obtained by waste recycling.

6. A dielectric composition for the manufacture of an insulating structure, according to claim 1, further characterized in that the granules have a size of granule in the range of 0.17 mm (80 mesh) to 11.2 mm (7/16 mesh).

7. A dielectric composition for the manufacture of an insulating structure, according to claim 1, further characterized in that the dielectric resin is selected among polyurethane, epoxy resins, polyester resins and/or combinations thereof.

8. A dielectric composition for the manufacture of an insulating structure, according to claim 7, further characterized in that the dielectric resin is polyurethane.

9. A dielectric composition for the manufacture of an insulating structure, according to claim 8, further characterized in that the polyurethane is obtained from isomers of toluene-diisocyanate and a polyol with molecular weight of approximately 3300.

10. A dielectric composition for the manufacture of an insulating structure, according to claim 9, further characterized in that 5-40 parts of isomers of toluene-diisocyanate per each hundred parts of polyol are used.

11. A dielectric composition for the manufacture of an insulating structure, according to claim 10, further characterized in that 8 to 33 parts of isomers of toluene-diisocyanate per each hundred parts of polyol are used.

12. An insulating structure of the type that comprises at least a dielectric resin characterized in that comprises at least a first substrate formed from a mixture of thermoset polymer with a dielectric resin in a ratio thermoset polymer/dielectric resin in the scale of 2:1 to 20:1, which allows it to support voltages of at least 45 kV and have resistances of at least 25 MΩ.

13. An insulating structure, according to claim 12, further characterized in that the ratio thermoset polymer/dielectric resin is 5:1.

14. An insulating structure, according to claim 13, further characterized in that the thermoset polymer is vulcanised rubber.

15. An insulating structure, according to claim 14, further characterized in that the rubber is selected between EPDM, SBR, natural rubbers, synthetic rubbers and/or combinations thereof.

16. An insulating structure, according to claim 12, further characterized in that the rubber is obtained from the waste recycling.

17. An insulating structure, according to claim 12, further characterized in that the granules have a size of granule in the range of 0.1 mm (80 mesh) to 11.2 m (7/16 mesh).

18. An insulating structure, according to claim 12, further characterized in that the dielectric resin is selected among polyurethane, epoxy resins, polyester resins, and/or combinations thereof.

19. A dielectric composition for the manufacture of an insulating structure according to claim 18, further characterized in that the dielectric resin is a polyurethane.

20. A dielectric composition for the manufacture of an insulating structure according to claim 19, further characterized in that the polyurethane is obtained from isomers of toluene diisocyanate and a polyol with molecular weight of approximately 3300.

21. A dielectric composition for the manufacture of an insulating structure according to claim 20, further characterized in that 5 to 40 parts of isomers of toluene diisocyanate per each hundred parts of polyol are used approximately.

22. A dielectric composition for the manufacture of an insulating structure according to claim 21, further characterized in that 8 to 33 parts of isomers of toluene diisocyanate per each hundred parts of polyol are used.

23. An insulating structure, according to any claims 13 to 22, further characterized in that comprises at least one dielectric resin substrate achieving an adequate dielectric strength of the insulating structure.

24. An insulating structure, according to claim 23, further characterized in that the insulating structure comprises a first substrate of thermoset polymer/dielectric resin; a second substrate of thermoset polymer/dielectric resin between the first and second substrates of thermoset polymer/dielectric resin.

25. An insulating structure, according to claim 23, further characterized in that comprises a substrate obtained from a thermoset polymer/dielectric resin mixture; a first substrate of dielectric resin located onto one of the surfaces of the substrate of the mixture thermoset polymer/dielectric resin; and a second substrate of dielectric resin located onto one surface of the substrate of thermoset polymer/dielectric resin mixture opposite to the surface where the first substrate is located.

26. An insulating structure, according to claim 23, further characterized in that the dielectric resin is selected among polyurethane, epoxy resins, polyester resins and/or combinations thereof.

27. A dielectric combination for the manufacture of an insulating structure according to claim 26, further characterized in that the dielectric resin is a polyurethane.

28. A dielectric composition for the manufacture of an insulating structure according to claim 27, further characterized in that the polyurethane is obtained from isomers of toluene diisocyanate and a polyol with molecular weight of approximately 3300,

29. A dielectric composition for the manufacture of an insulating structure according to claim 28, further characterized in that 5 to 40 parts of isomers of toluene diisocyanate per each 100 parts of polyol approximately are used.

30. A dielectric composition for the manufacture of an insulating structure according to claim 29, further characterized in that 8 to 33 parts of isomers of toluene diisocyanate per each 100 parts of polyol are used.
